(19) United States
(12) Patent Application Publication
(10) Pub. No.: US 2005/0279413 A1
(43) Pub. Date: Dec. 22, 2005

(54) Flow control switch

(76) Inventor: Der-Fan Shen, Shan-Chung City (TW)

Correspondence Address: PRO-TECHTOR INTERNATIONAL, 20775 Norada Court, Saratoga, CA, 95070-3018, US

(21) Appl. No.: 10/871,099

(22) Filed: Jun. 18, 2004

(51) Int. Cl. F16K 37/00

(52) U.S. Cl. 137/554; 200/81.5

(57) ABSTRACT

A flow control switch comprises a base, having a passageway and a chamber; a valve body, placed between said passageway and said chamber; an inner cover, fastened to said base on an upper side thereof and having a central hole; a central pole, attached to said valve body and passing through said inner cover, defining a vertical direction; an outer cover, mounted on said inner cover at an adjustable vertical position; and a switch assembly, having a contact ring which is mounted on said central pole and a conducting surface which is mounted on said outer cover; wherein flow of liquid pushes said central pole upward, causing said switch assembly to establish electrical contact, so that a signal indicating flow of liquid is generated, allowing for application of the flow control switch to various environments.

### BACKGROUND OF THE INVENTION

1. Field of the Invention

The present invention relates to a flow control switch, particularly to a flow control switch with a sensor for a flow rate of any liquid through a pipe, delivering a signal for controlling operation of a pump, with an additional manual mode allowing to close the switch for initiating generation of liquid pressure for operational and testing purposes.

2. Description of Related Art

Conventional pipe systems with pumps, e.g., pipe systems for wells and ground water or closed systems, have switches built in supply pipes, which generate control signals for operating pumps.

As shown in FIG. 8, Taiwan patent publication no. 267531“Swaying liquid flow switch” discloses an apparatus comprising a main body 80, a magnetic switch 81, and a swaying plate 82. The main body 80 is a hollow body with an inlet 801 and an outlet 802 for liquid. The magnetic switch 81 is mounted on the main body 80. The swaying plate 82 is attached to an inner wall of the main body 80, reaching inward. At a low flow rate of liquid through the main body 80, liquid passes through a gap between an inner wall of the main body 80 and the swaying plate 82 and will not hit the swaying plate 82. In this state, the magnetic switch 81 does not issue a signal. Only at a high flow rate of liquid through the main body 80, liquid pushes the swaying plate 82 against an inner wall of the main body 80, closing the magnetic switch 81, which subsequently issues a signal.

The swaying liquid flow switch just described is suitable for medium and large flow rates of liquid. At low flow rates of liquid, however, the magnetic switch 81 does not issue a signal. Therefore, the swaying liquid flow switch just described is not applicable to all environments.

As shown in FIG. 9, Taiwan patent publication no. 159577“Automatic switch for idle-running pump” discloses a control switch 90 having a main body 91, a ferromagnetic piston 92, a spring 93, which by an elastic force pushes the ferromagnetic piston 92 on an inlet, a magnetic switch 94, an electric heater 95, which is a resistor, a bimetallic temperature-sensitive switch 96, which, depending on temperature, contacts an contact point 97. When liquid passes through the control switch 90, the ferromagnetic piston 92 is pushed away from the inlet, so that the magnetic switch 94 does not issue a signal, and a liquid pump (not shown) starts operating. When no liquid passes through the control switch 90, the spring 93 pushes the ferromagnetic piston 92 towards the inlet, so that the magnetic switch 94 issues a signal. In this state, the electric heater 95 generates heat, causing the bimetallic temperature-sensitive switch 96 to become detached from the contact point 97, so that the liquid pump stops operating. The control switch 90 is able to work at all flow rates. However, the magnetic switch 94 is not adjustable for changing a working range, so that the control switch 90 is still not suitable for all operating environments.

To summarize, conventional flow switches and control systems have the shortcoming of not sensing at a full range of flow rates and not being adjustable thereto.

### SUMMARY OF THE INVENTION

It is therefore an object of the present invention to provide a flow control switch which is able to sense flow rates at a full range, comprising a base, a valve body, an inner cover, a central pole, an outer cover, and a switch assembly, with the base having a passageway and a chamber, connected by the valve body, the inner cover being tightly set on an upper side of the base, the central pole being mounted on the valve body, passing through the inner cover, and the switch assembly having a contact ring driven by the central pole and a conducting surface fixed on the outer cover and conducting an electric current for generating a signal dependent on a vertical position of the central pole.

Another object of the present invention is to provide a flow control switch which allows finely to adjust a minimal sensing point for sensing liquid flow, by the outer cover having an adjustable vertical position, allowing to set a well-defined minimum sensing position of the central pole, thus allowing for application of the flow control switch in various operating environments.

A further object of the present invention is to provide a flow control switch which upon insufficient pressure of liquid allows to initiate generation of liquid pressure manually by pushing down the outer cover.

The present invention can be more fully understood by reference to the following description and accompanying drawings.

### DETAILED DESCRIPTION OF THE PREFERRED EMBODIMENTS

As shown in FIGS. 1 and 2, the present invention is a flow control switch 1 comprising: a base 10; a valve body 20; an inner cover 30; a central pole 40; an outer cover 50; and a switch assembly 60. The flow control switch 1 is used in conjunction with a pump 70. The pump 70 has an outlet 71 on which the base 10 of the flow control switch 1 is mounted. Liquid, after having passed through the flow control switch 1 is fed into a supply pipe system 72. A pressure container 73 is set on the pump 70. The pump 70 further has an inlet 74 with a backflow-blocking valve 75. When the pump 70 sucks in liquid through the inlet 74 and liquid pressure is sufficiently large, liquid on the side of the supply pipe system 72 pushes up the central pole 40, with the switch assembly 60 sensing liquid flow over a complete range of flow rates and issuing a signal. Adjusting the outer cover 50 allows to set a minimal sensing point for adapting to any given operating environment. Below, a more detailed explanation is given.

The base 10 has a passageway 11 and a chamber 12, separated by a flange 13. Liquid passes through the passageway 11 and rises vertically to enter the chamber 12.

A sealing ring 21 tightly seals the flange 13 against walls of the passageway 11, preventing flowing of liquid from the chamber 12 back to the passageway 11. The valve body 20 further has a central hole 22, through which the central pole 40 passes, and several guiding pins 23, reaching downward with gaps left in between through which liquid flows. When liquid passes from the passageway 11 to the chamber 12, the valve body 20 rises accordingly.

The inner cover 30 is fastened to the base 10 by fastening elements 31. The inner cover 30 has a central hole 32, through which the central pole 40 passes.

The central pole 40 has a lower end which passes through the central hole 22 of the valve body 20. A blocking part 41 near the lower end of the central pole 40 blocks slipping thereof through the central hole 22. A nut 42 secures the central pole 40 on the valve body 20. The central pole 40 at a middle section thereof passes through the central hole 32 of the inner cover 30. A sealing element 33 and an attenuating ring 34 prevent liquid from leaking out of the chamber 12 through the central hole 32. The central pole 40 further has an upper end surrounded by the switch assembly 60. A spring 43 is inserted between the valve body 20 and the inner cover 30, pushing the valve body 20 onto the flange 13, thus blocking backflow of liquid. Another spring 44 is inserted between the inner cover 30 and the switch assembly 60, pushing the switch assembly 60 upward with a well-defined force. The spring 43 has an elastic force that is greater than the elastic force of the spring 44 for operating the valve body 20.

The outer cover 50 has a lower shoulder on which several adjusting screws 51 are mounted. The adjusting screws 51 fasten the outer cover 50 on the inner cover 30. On each of the adjusting screws 51 a spring 52 is put, pressing the outer cover 50 upward. Turning the adjusting screws 51 allows to adjust a vertical position of the outer cover 50. A positioning channel 53 with an inner opening 54 fixes a horizontal position of the outer cover 50.

The switch assembly 60 at the upper end of the central pole 40 has an insulating plate 61, against which the spring 44 leans. A contact ring 62 is laid on an upper side of the insulating plate 61. The positioning channel 53 has a lower side with a conducting surface 63. A fixing element 64 is fastened to the upper end of the central pole 40, preventing the insulating ring 61 from getting loose and ensuring that a preset distance between the contact ring 62 and the conducting surface 63 is maintained. The fixing element 64 is placed inside the inner opening 54 of the positioning channel 53 of the outer cover 50, guiding the central pole 40, so that the contact ring 62 and the conducting surface 63 contact each other in a precise, well-defined way.

When no liquid flows through the passageway 11, the valve body 20 remains in a closed state, pressed down on the flange 13 by the spring 43. In this state, the contact ring 62 and the conducting surface 63 do not contact each other, no electric current passes from the contact ring 62 to the conducting surface 63, and no signal is issued.

Referring to FIG. 3, when liquid flows through the passageway 11 is sufficient to overcome the elastic force of the springs 43 and 44, the valve body 20 is raised, allowing liquid to flow through the gaps of the guiding pins 23 into the chamber 12. The central pole 40 rises along with the valve body 20, with the fixing element 64 gliding in the inner opening 54 of the positioning channel 53, causing the contact ring 62 and the conducting surface 63 to contact each other, so that an electric current passes from the contact ring 62 to the conducting surface 63, and a signal is issued.

Referring to FIG. 4, when liquid flows through the passageway 11 increases further and the valve body 20 and the central pole 40 are raised further, the contact ring 62 is by the elastic force of the spring 44 continued to be pressed against the conducting surface 63, so that a signal is still issued.

Referring to FIG. 5, at a maximum flow of liquid through the passageway 11, the fixing element 64 in the inner opening 54 of the positioning channel 53 has reached an uppermost position, and the contact ring 62 keeps to be pressed against the conducting surface 63 by the elastic force of the spring 44, so that a signal continues to be issued.

Thus at any flow rate above a minimum value, the contact ring 62 and the conducting surface 63 contact each other, and a signal is issued.

The adjusting screws 51 of the outer cover 50 allow to set a minimum sensing position of the central pole 40 at which the contact ring 62 and the conducting surface 63 contact each other, and a signal is issued. Furthermore, as shown in FIG. 6, when an insufficient amount of liquid is sucked by the pump 70 through the inlet 74, the outer cover 50 allows to be pressed down manually, compressing the springs 52 and bringing the contact ring 62 and the conducting surface 63 into mutual contact, so that the pump 70 is manually started for operational or testing purposes.

Referring to FIG. 7, the present invention in a second embodiment has an inner cover 30a and an outer cover 50a, which are engaged to each other by threads. Turning the outer cover 50a against the inner cover 30a allows to adjust a vertical position thereof and thus an initial distance between the the contact ring 62 and the conducting surface 63 for setting a minimum sensing vertical position of the central pole 40.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a side view of the flow control switch of the present invention in conjunction with a pump.

FIG. 2 is a sectional view of the flow control switch of the present invention with no flow of liquid.

FIG. 3 is a sectional view of the flow control switch of the present invention with a small flow of liquid.

FIG. 4 is a sectional view of the flow control switch of the present invention with an increased flow of liquid.

FIG. 5 is a sectional view of the flow control switch of the present invention with maximum flow of liquid.

FIG. 6 is a sectional view of the flow control switch of the present invention during manual operation.

FIG. 7 is a sectional view of the flow control switch of the present invention in the second embodiment.

FIG. 8 (prior art) is a sectional view of a conventional swaying liquid flow switch.

FIG. 9 (prior art) is a sectional view of a conventional automatic switch for an idle-running pump.

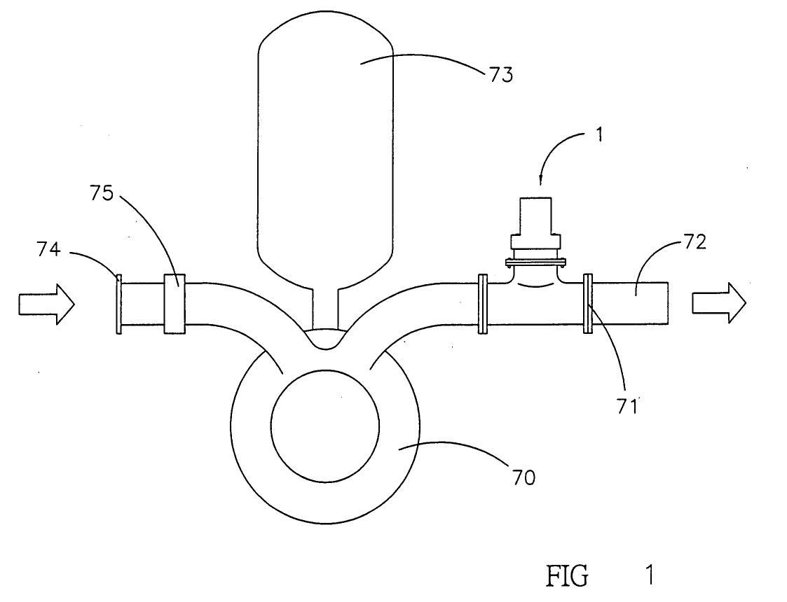

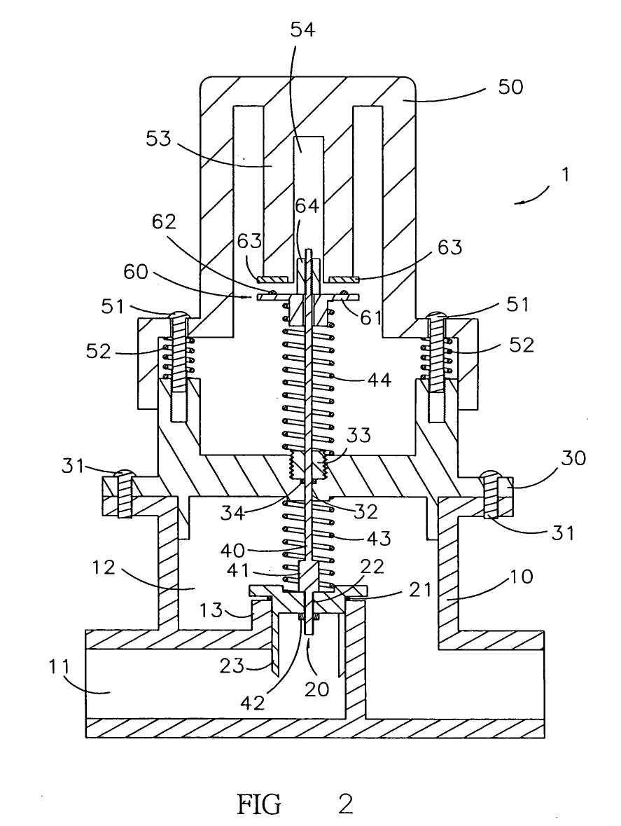

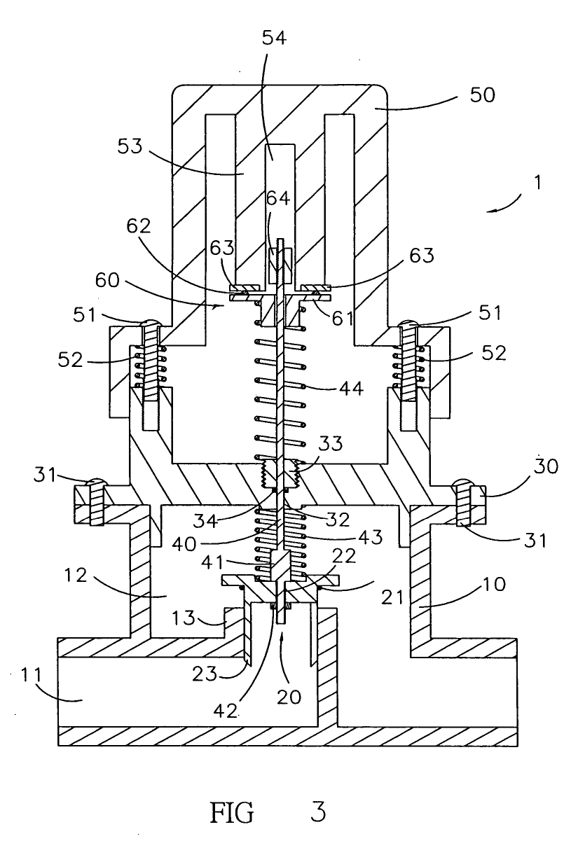

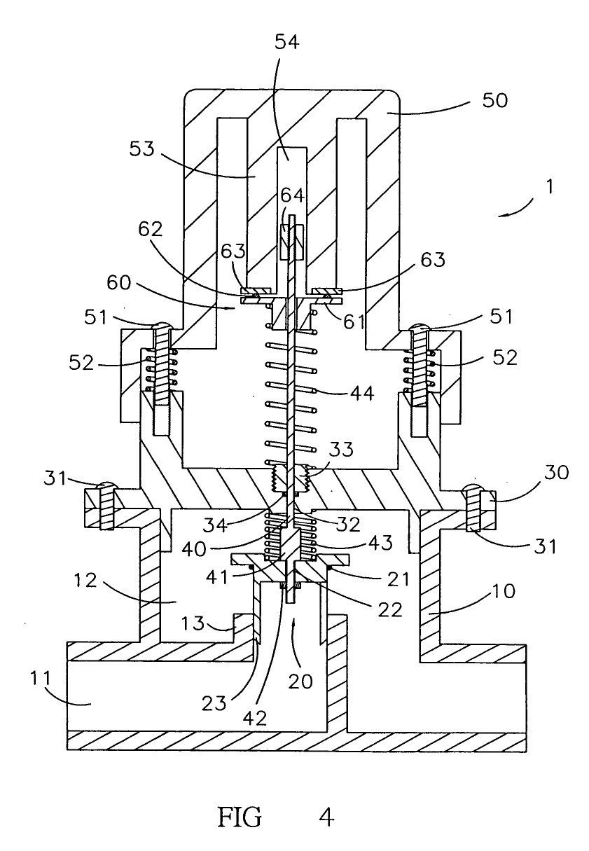

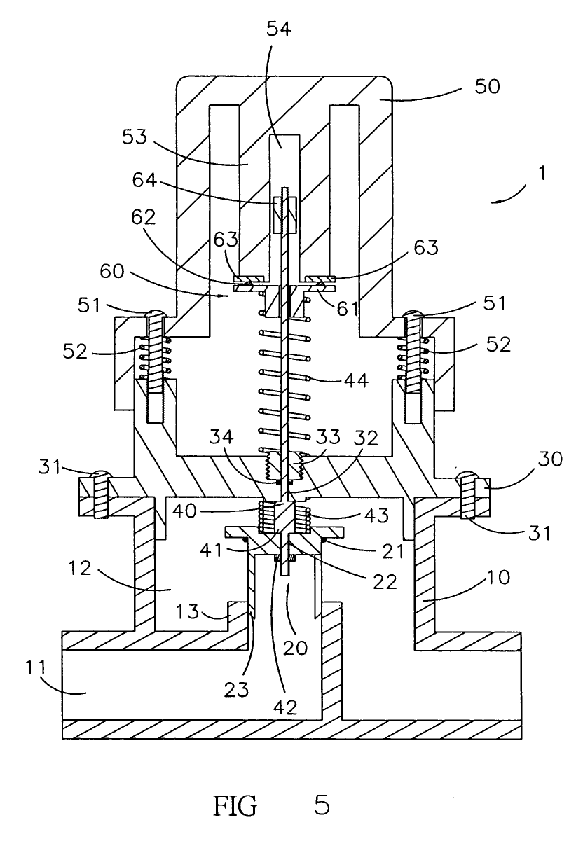

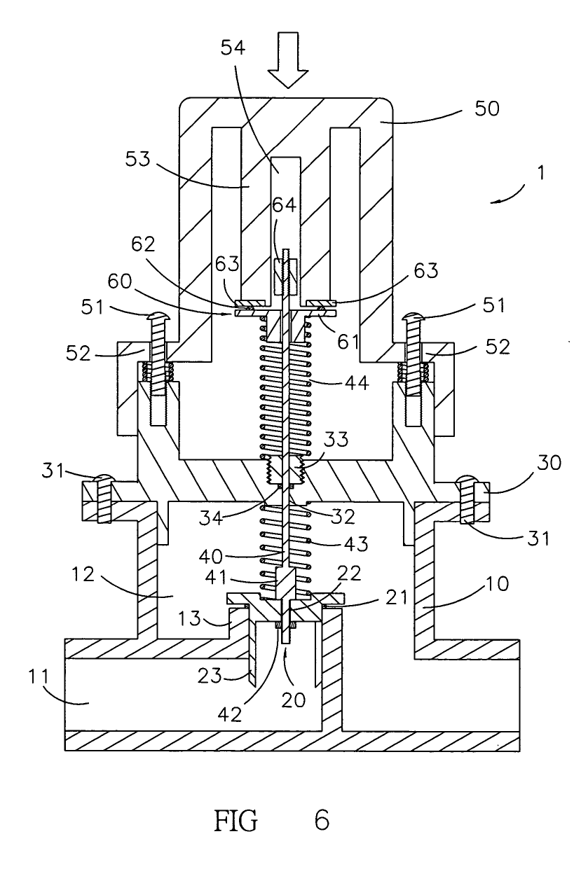

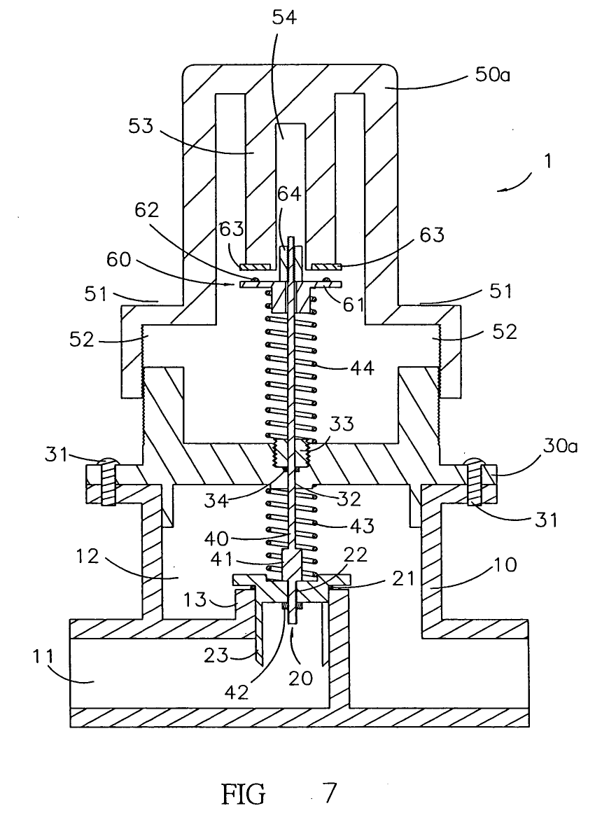

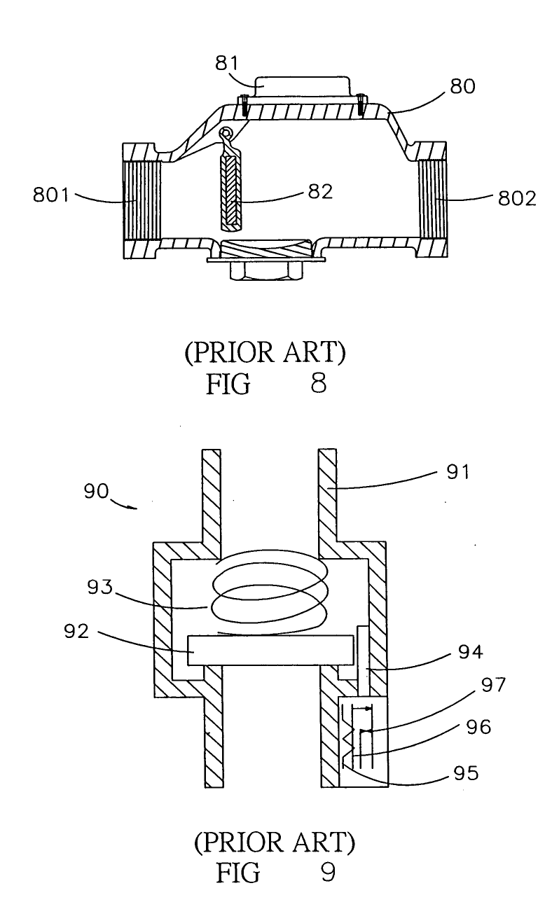

1. A flow control switch comprising:
a base, having a passageway and a chamber;
a valve body, placed between said passageway and said chamber;
an inner cover, fastened to said base on an upper side thereof and having a central hole;
a central pole, attached to said valve body and passing through said inner cover, defining a vertical direction;
an outer cover, mounted on said inner cover at an adjustable vertical position; and
a switch assembly, having a contact ring which is mounted on said central pole and a conducting surface which is mounted on said outer cover;
wherein flow of liquid pushes said central pole upward, causing said switch assembly to establish electrical contact, so that a signal indicating flow of liquid is generated.

2. The flow control switch according to claim 1, wherein a flange is mounted between said passageway and said chamber.

3. The flow control switch according to claim 1, wherein said valve body on a lower side has a plurality of guiding pins, with gaps in between allowing for passage of liquid.

4. The flow control switch according to claim 1, wherein said central pole has a lower end which passes through said valve body, with a blocking part fixed to said central pole above said valve body and a nut securing said central pole on said valve body.

5. The flow control switch according to claim 1, wherein said central pole at a position inside said inner cover has a sealing element and an attenuating ring.

6. The flow control switch according to claim 1, wherein a spring is put over said central pole between said valve body and said inner cover, so that said valve body is pressed downward.

7. The flow control switch according to claim 1, wherein a spring is put over said central pole between said switch assembly and said inner cover, so that said switch assembly is pressed upward.

8. The flow control switch according to claim 1, wherein said outer cover has a positioning channel with an inner opening.

9. The flow control switch according to claim 7, wherein said switch assembly has a insulating plate, passed through by said central hole and leant against by said spring, with said contact ring being laid on said insulating surface, wherein further wherein said outer cover has a positioning channel with an inner opening, with said positioning channel having a lower side on which said conducting surface is placed, and wherein a fixing element is attached to said central pole on an upper end thereof, being placed inside said inner opening of said positioning channel, so that said contact ring and said conducting surface maintain a well-defined mutual distance.

10. The flow control switch according to claim 1, wherein said outer cover has a peripheral shoulder with screws, fastening said outer cover to said inner cover, with springs between said outer cover and said inner cover pressing said outer cover upward, so that a vertical position of said outer cover is either adjusted by said screws or lowered by manual pressing down of said outer cover.

11. The flow control switch according to claim 1, wherein said outer cover engages with said inner cover by a thread.
